(19) United States
(12) Patent Application Publication
(10) Pub. No.: US 2026/0029859 A1
(43) Pub. Date: Jan. 29, 2026

(54) MODULAR CONTROL DEVICE

(71) Applicant: Cooler Master Technology Inc., Taipei City (TW)

(72) Inventor: Bryant Quac Bao Manh Nguyen, Taipei City (TW)

(73) Assignee: Cooler Master Technology Inc., Taipei City (TW)

(21) Appl. No.: 19/350,815

(22) Filed: Oct. 6, 2025

Related U.S. Application Data
(63) Continuation-in-part of application No. 18/661,565, filed on May 10, 2024.

(30) Foreign Application Priority Data
May 12, 2023 (TW) 112117615
Oct. 7, 2024 (TW) 113210791

(51) Int. Cl. G06F 3/02; G06F 3/0354; G06F 3/0362

(52) U.S. Cl. CPC G06F 3/0227; G06F 3/03547; G06F 3/0362

(57) ABSTRACT

Aspects of the disclosure provide a modular control device. The modular control device includes a module base having a main control body having a plurality of first electrical connectors and a plurality of first positioning structures, and an expandable control body having a plurality of first electrical connectors and a plurality of first positioning structures, wherein the expandable control body is movably positioned with respect to the main control body and configured to move between a retracted position and an extended position, and a plurality of electronic modules, each electronic module having a second electrical connector and a plurality of second positioning structures, wherein each electronic module is detachably connectable to the module base via connection of the second electrical connector to one of the first electrical connectors and positioning of the second positioning structures with the first positioning structures for electrical connection and mechanical positioning.

### RELATED APPLICATIONS

This application is a continuation-in-part of U.S. application Ser. No. 18/661,565, filed May 10, 2024, which claims priority under 35 U.S.C. § 119(a) to Taiwan application No. 112117615, filed on May 12, 2023. This application also claims priority under 35 U.S.C. § 119(a) to Taiwan Application No. 113210791, filed on Oct. 7, 2024, the entire contents of all applications are incorporated herein by reference.

### TECHNICAL FIELD

The present disclosure is related to control devices in general and more particularly but not limited to modular control devices.

### BACKGROUND

Editing consoles, control decks, and control panels, are control devices with shortcut buttons and controls such as knobs, dials, trackballs, encoder rings, sliders, scroll bars, trackpads and pressure pads, and touchscreen displays, for audio-, video- or image-editing, controlling live streaming, and browsing the internet. Generally, editing consoles have default layouts which can auto-detect which industry-standard application is being used to adjust the functionalities of buttons and controls of the console. For non-industry-standard applications, some editing consoles also offer customizable shortcut buttons and controls for different set-ups. For most, console layouts are fixed, thus, physical customization of the consoles are not available, which makes it inconvenient for users wanting different placement of the buttons and controls and/or different vertical or horizontal positions of the console.

### SUMMARY

Aspects of the disclosure provide a modular control device. The modular control device includes a module base having a main control body having a plurality of first electrical connectors and a plurality of first positioning structures, and an expandable control body having a plurality of first electrical connectors and a plurality of first positioning structures, wherein the expandable control body is movably positioned with respect to the main control body and configured to move between a retracted position and an extended position, and a plurality of electronic modules, each electronic module having a second electrical connector and a plurality of second positioning structures, wherein each electronic module is detachably connectable to the module base via connection of the second electrical connector to one of the first electrical connectors and positioning of the second positioning structures with the first positioning structures for electrical connection and mechanical positioning.

In an embodiment, the module base can further include a control body connector connecting the expandable control body to the main control body and configured to facilitate movement of the expandable control body between the retracted position and the extended position.

In an embodiment, when the expandable control body is in the retracted position, the module base has dimensions of approximately 15×6, and when the expandable control body is in the extended position, the module base has dimensions of approximately 17×6.

In an embodiment, the expandable control body can be configured to move with respect to the main control body between the retracted position and the extended position via the control body connector.

In an embodiment, the plurality of electronic modules can be positioned across both the main control body and the expandable control body.

In an embodiment, the plurality of electronic modules can include at least one of a keyboard module, a touchpad module, a button module, an audio module, a touchscreen module, a rotary knob module, or a scroll module.

For example, the keyboard module can include a 60%, 80%, or 100% size configuration. For example, the touchscreen module can include a 4 inch, 4.6 inch, or 5 inch display. For example, the scroll module can include 2 scroll wheels. For example, the rotary knob module can include 3 knobs. For example, the button module can include 4 buttons. For example, the audio module can include 5 adjustment sliders.

In an embodiment, the first electrical connectors and second electrical connector can include universal serial bus (USB) interfaces. In an embodiment, the electrical connection between the first electrical connectors and the second electrical connector can be a wireless connection.

### BRIEF DESCRIPTION OF DRAWINGS

Unless specified otherwise, the accompanying drawings illustrate aspects of the innovative subject matter described herein. Referring to the drawings, wherein like reference numerals indicate similar parts throughout the several views, several examples of modular control devices incorporating aspects of the presently disclosed principles are illustrated by way of example, and not by way of limitation.

FIG. 1A is a perspective view of a modular control device according to one embodiment of the present disclosure.

FIG. 1B is an exploded view of the modular control device of FIG. 1 according to one embodiment of the present disclosure.

FIG. 2 is a perspective view of another modular control device according to one embodiment of the present disclosure.

FIG. 3 is a perspective view of yet another modular control device according to one embodiment of the present disclosure.

FIG. 4 is a perspective view of yet another modular control device according to one embodiment of the present disclosure.

FIG. 5 is an exploded view of the modular control device of FIG. 4 according to one embodiment of the present disclosure.

FIG. 6 is a perspective view of the module base of the modular control device of FIG. 4 according to one embodiment of the present disclosure.

FIG. 7 is another perspective view of the modular control device of FIG. 4 according to one embodiment of the present disclosure.

FIG. 8 is a perspective view of one type of electronic module of the modular control device of FIG. 4 according to one embodiment of the present disclosure.

FIG. 9 is a perspective view of another type of electronic module of the modular control device of FIG. 4 according to one embodiment of the present disclosure.

### DETAILED DESCRIPTION

The following describes various principles related to modular control devices by way of reference to specific examples of electronic modules and module bases, including specific arrangements and examples of electronic modules, module bases, and retention joints embodying innovative concepts. More particularly, but not exclusively, such innovative principles are described in relation to selected examples of module interfaces, retention interfaces, and input of control information via buttons, rotary knobs, sliders, scroll bars, and touchscreens, and well-known functions or constructions are not described in detail for purposes of succinctness and clarity. Nonetheless, one or more of the disclosed principles can be incorporated in various other embodiments of different module interfaces, different retention interfaces, and input of control information via means different from buttons, rotary knobs, sliders, scroll bars, and touchscreens to achieve any of a variety of desired outcomes, characteristics, and/or performance criteria.

Thus, electronic modules and retention joints having attributes that are different from those specific examples discussed herein can embody one or more of the innovative principles, and can be used in applications not described herein in detail. Accordingly, embodiments of electronic modules and retention joints not described herein in detail also fall within the scope of this disclosure, as will be appreciated by those of ordinary skill in the relevant art following a review of this disclosure.

Example embodiments as disclosed herein are directed to control devices such as editing consoles, editing decks, and editing panels for audio-editing, video-editing, live streaming, and internet browsing, among others. For video-editing and audio-editing, the control devices can cut video and audio, reduce video and audio noise, combine video and audio content, modify video and audio content, add effects to video and audio, adjust audio volume, and adjust video color and brightness, among other controls. Video-editing control devices can also function as image-editing control devices. Image-editing control devices can correct image colors, crop and sharpen images, reduce image noise, and composite and retouch images, among other controls. Modular control devices are control devices that have modules which can be added, modified, replaced, and programed to control at least one of audio-editing, video-editing, live streaming, and internet browsing, or any combination of the foregoing. Buttons can have functionalities such as copy, paste, presets, photoshop actions, and starting macros, among other functionalities. Knobs and dials can have functionalities such as adjusting tones, levels, and color grading, among other functionalities. Sliders can be used for horizontal or vertical adjustments, and real-time audio control, among other functionalities. Scroll bars can be used for content scrolling and zooming in and zooming out, among other functionalities. Touchscreens can be used for screen display and any physical control, such as those available for user via a keyboard, among other functionalities. The electronic modules of the disclosure are configured to provide input control information to one or more applications, controlling one or more inputs of an app by an application program. Each of the plurality of electronic modules can be configured by a user.

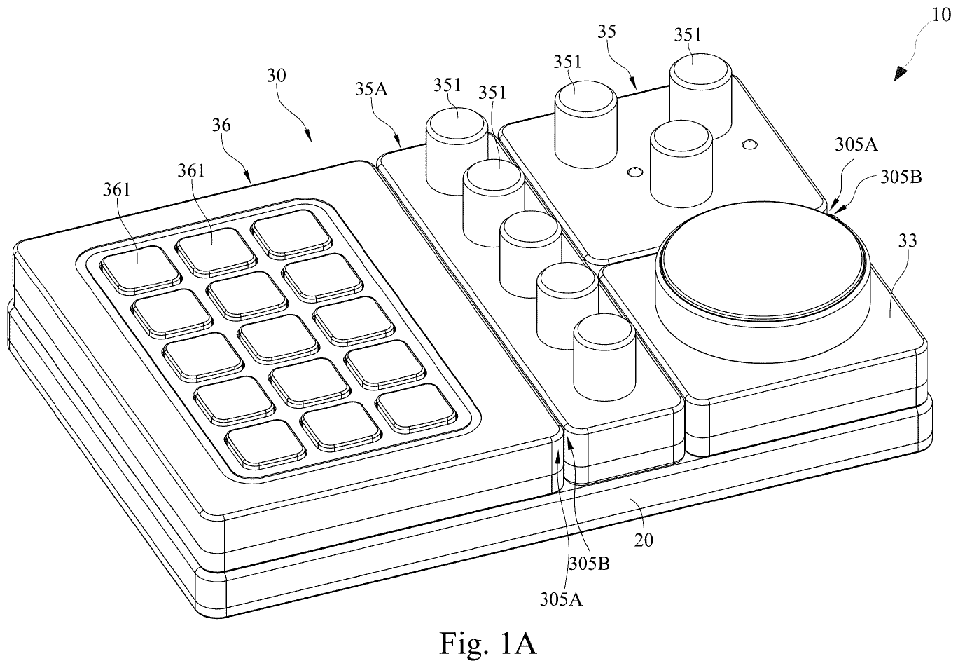

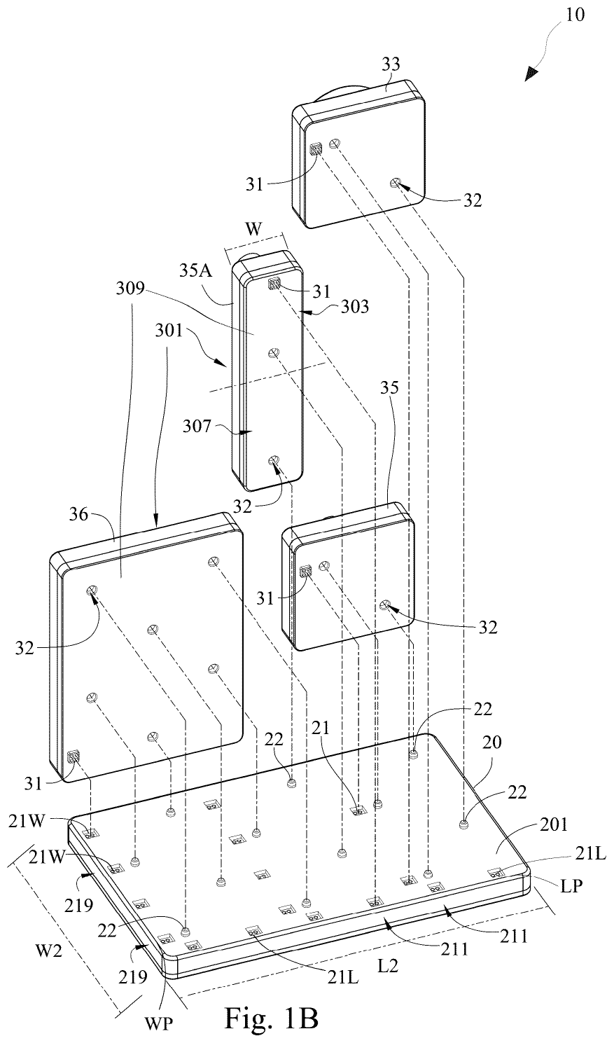

FIGS. 1A and 1B include at least one embodiment of a modular control device 10. The modular control device 10 includes a plurality of electronic modules 30, a module base 20, and at least two or more retention joints 31/21, 32/22 is provided. Each plurality of electronic modules 30 has a function surface 301 and a retention surface 309 opposite the function surface 301. The retention surface 309 defines a first portion 303 and a second portion 307 divided along a width W thereof. Both the first portion 303 and the second portion 307 are equally a half surface area of the retention surface 309. The module base 20 has a mounting surface 201 adapted to respectively receive the retention surfaces 309 of the plurality of electronic modules 30. Each of the at least two or more retention joints 31/21, 32/22 has a module member 31/32 associated with the retention surface 309 and a base member 21/22 associated with the mounting surface 201. One of the at least two or more retention joints 31/21, 32/22 is positioned within the first portion 303 and one other of the at least two or more retention joints 31/21, 32/22 is positioned within the second portion 307. Either the one or the one other of the at least two or more retention joints 31/21, 32/22 respectively define a module interface 31/21 and the one other or the one of the at two or more retention joints respectively define a retention interface 32/22.

In at least one embodiment, the module base 20 receives the retention surface 309 of each plurality of electronic modules 30 via the at least two or more retention joints 31/21, 32/22. In at least one embodiment, at least one of the module interface 31/21 and the retention interface 32/22 includes a snap-fit joint connection. Each plurality of electronic modules 30 is engaged to and disengaged from the module base 20 via the snap-fit joint connection. A snap-fit joint connection has one component with at least one protruding part, for example, a hook, stud or bead, being deflected briefly during a joining operation, to be caught in a depression (undercut) in another mating component, where the one component returns to a stress-free condition. An annular snap-fit joint is a joint between two rotationally symmetric components. In at least one embodiment, each plurality of electronic modules 30 further includes a cuboid shape and the function surface 301 and the retention surface 309 are both the largest surface areas of each plurality of electronic modules 30. In at least one embodiment, at least one side 305A of each plurality of electronic modules 30 is adjacent to one side of an other 305B of the plurality of electronic modules 30, supporting engagement of each plurality of electronic modules 30 to the module base 20.

In at least one embodiment, the function surface 301 of each plurality of electronic modules 30 is configured for input of control information. In at least one embodiment, the plurality of electronic modules 30 further includes two or more electronic modules 30, each selected from the following group of electronic modules: a button module 36, 36A, a rotary knob module 35, a slider module 37, a scroll bar module 34, and a touchscreen module 33, 33A, or any combination of the foregoing, each configured for providing the input of control information. In at least one embodiment, the button module 36, 36A comprises one or more buttons 361, the rotary knob module 35 comprises one or more rotary knobs 351, the slider module 37 comprises one or more sliders 371, and the scroll bar module 34 comprises one or more scroll bars 341. In at least one embodiment, the one or more buttons 361 of the button module 36, 36A comprise at least one of buttons, virtual keys, and mechanical keys, or any combination of the foregoing.

In at least one embodiment, the two or more electronic modules 30 further include at least one first electronic module 36, at least one second electronic module 35, at least one other second electronic module 35A, and at least one fifth electronic module 33, wherein the at least one first electronic module 36 is a button module 36 for generating physical or virtual inputs, the at least one second electronic module 35 and the at least one other second electronic module 35A are rotary knob modules 35, 35A for adjusting parameters, and the at least one fifth electronic module 33 is a touchscreen module 33 configured for screen display and device input.

In at least one embodiment, the module interface 31/21 includes a module connector 31 and a module port 21 and the retention interface 32/22 includes a fastener slot 32 and a fastener prong 22. The module connector 31 is defined by one module member 31 and the module port 21 is defined by one corresponding base member 21. The module connector 31 is mounted within and electrically coupled to the module port 21. The fastener slot 32 is defined by one other module member 32 and the fastener prong 22 is defined by one other corresponding base member 22. The fastener prong 22 is mounted within the fastener slot 32. In at least one embodiment, the fastener prong 22 is convex shaped and the fastener slot 32 is concave shaped.

In at least one embodiment, the module interface 31/21 includes a universal serial bus (USB) interface. The module interface 31/21 exchanges data and delivers power between components in an electronics system. USB form factors include USB Type-A, Type-B, Mini-A, Mini-B, Micro-A, Micro-B, Type-C. USB3.2 Gen 1×1 exchanges data over USB-A, USB-C, micro USB cables at speeds of at least 5 Gbps. USB4 Version 2 exchanges data over USB Type-C cables at speeds of at least 80 Gbps.

In at least one embodiment, the mounting surface 201 includes a width W2 and a length L2 and the base member 21/22 includes a plurality of base members 21/22. The plurality of base members 21/22 is disposed in at least two or more columns 219 parallel to the length L2 and at least two or more rows 211 parallel to the width W2. In at least one embodiment, the plurality of base members 21/22 include a plurality of width edge base members 21W, a plurality of length edge base members 21L, and a plurality of internal base members 21/22. The plurality of width edge base members 21W is disposed parallel to one width perimeter WP of the mounting surface 201. The plurality of length edge base members 21L is disposed parallel to one length perimeter LP of the mounting surface 201. The plurality of internal base members 21/22 is disposed between the plurality of width edge base members 21W and an opposite width perimeter of the one width perimeter WP of the mounting surface 201 and between the plurality of length edge base members 21L and an opposite length perimeter of the mounting surface 201.

In at least one embodiment, each plurality of width edge base members 21W and each plurality of length edge base members 21L include the module port 21. In at least one embodiment, a distance between each plurality of width edge base members 21W is the same and a distance between each plurality of length edge base members 21L is the same.

In at least one embodiment, the plurality of width edge base members 21W include four width W edge base members 21W, the plurality of length edge base members 21L include six length edge base members 21L, and the plurality of internal base members 21/22 include eighteen internal base members 21/22. In at least one embodiment, the eighteen internal base members 21/22 include six module ports 21 and twelve fastener prongs 22.

In at least one embodiment, at least one of the button module 36, 36A includes five buttons or fifteen buttons, the rotary knob module 35 includes three rotary knobs, the slider module 37 includes five sliders, the scroll bar module 34 includes two scroll bars, and the touchscreen module 33, 33A includes a 1.3 inch touchscreen, a 4.3 inch touchscreen, or a 8.5 inch touchscreen, or any combination of the foregoing.

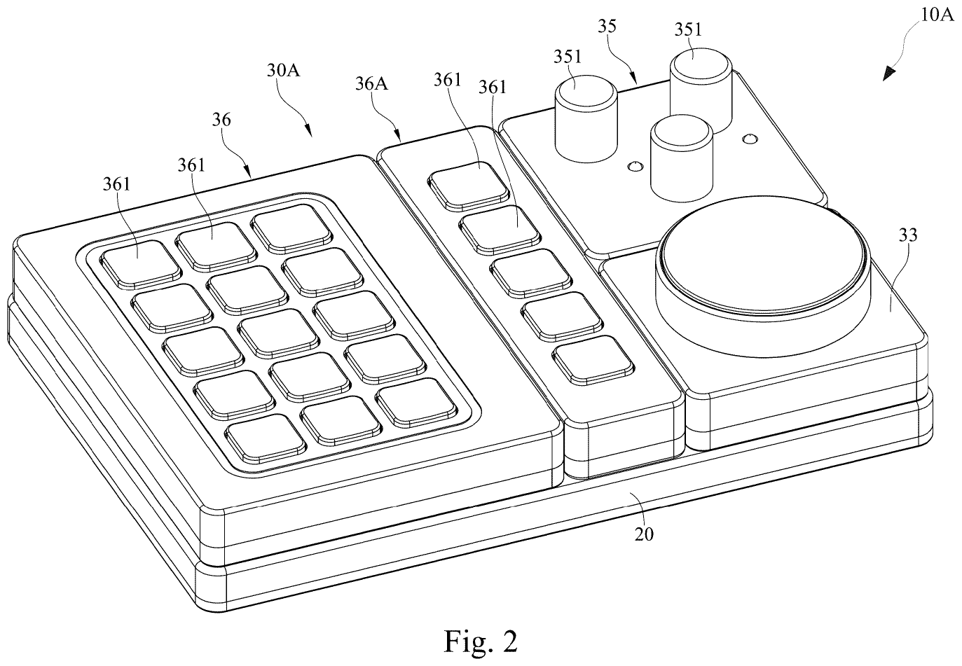

FIG. 2 includes at least one embodiment of another modular control device 10A. The two or more electronic modules 30A include at least one first electronic module 36, at least one other first electronic module 36A, at least one second electronic module 35, and at least one fifth electronic module 33. The another modular control device 10A may be similar in some respects to the modular control device 10 of FIGS. 1A and 1B, and therefore may be best understood with reference thereto where like numerals designate like components not described again in detail. The at least one first electronic module 36 and the at least one other first electronic module 36A are button modules 36, 36A for generating physical or virtual inputs, the at least one second electronic module 35 is a rotary knob module 35 for adjusting parameters, and the at least one fifth electronic module 33 is a touchscreen module 33 configured for screen display and device input.

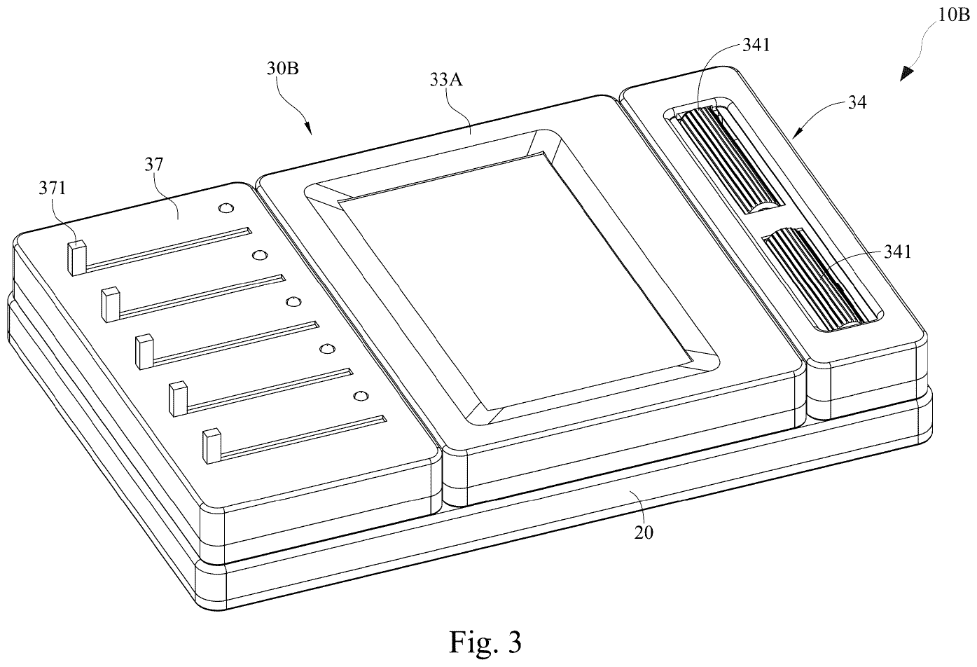

FIG. 3 includes at least one embodiment of yet another modular control device 1-0B. The two or more electronic modules 30B include at least one third electronic module 37, at least one fourth electronic module 34, and at least one other fifth electronic module 33A. The yet another modular control device 10B may be similar in some respects to the modular control device 10 of FIGS. 1A and 1, and therefore may be best understood with reference thereto where like numerals designate like components not described again in detail. The at least one third electronic module 37 is a slider module 37 configured for adjusting playback volume, the at least one fourth electronic module 34 is a scroll bar module 34 configured for content scrolling, and the at least one other fifth electronic module 33A is a touchscreen module 33A configured for screen display and device input.

In at least one embodiment for assembly of the modular control device 10, 10A, 10B, a preferred vertical, horizontal, or angled position of the module base 20 is chosen. Then, based on the preferred positioning, a customized combination of the plurality of electronic modules 30, 30A, 30B (‘modules’) having a most ideal layout of button modules 36, 36A, rotary knob modules 35, slider modules 37, scroll bar modules 34, and/or touchscreen modules 33, 33A, for audio-editing, video-editing, live streaming, and/or internet browsing, are snap-fit pressed onto the mounting surface 201 of the module base 20 for engagement and electrical coupling of the ‘modules’ to the module base 20. The most ideal layout of ‘modules’ can be placed anywhere on the mounting surface 201, whereby the at least one side 305A of each plurality of electronic modules 30, 30A, 30B is adjacent to one side of an other 305B of the plurality of electronic modules 30, 30A, 30B, supporting engagement of each plurality of electronic modules 30, 30A, 30B to the module base 20, and one of the at least two or more retention joints 31/21, 32/22 is positioned within the first portion 303 of the retention surface 309 and one other of the at least two or more retention joints 31/21, 32/22 is positioned within the second portion 307 of the retention surface 309.

In at least one embodiment for disassembly of the modular control device 10, 10A, 10B, the plurality of electronic modules 30, 30A, 30B can be disengaged from the mounting surface 201 of the module base 20 by being pulled up from the mounting surface 201. For reassembly, the above steps can be repeated.

The modular control devices 10, 10A, 10B of the present disclosure provide a variety of customizable layouts for a single control device. A user will not need to purchase a second control device for a default layout geared mainly for only one of audio-editing, video-editing, live streaming, or internet browsing, while requiring two or more different editing functionalities. For control devices offering default layouts geared for more than one of audio-editing, video-editing, live streaming, or internet browsing, generally, depending upon which editing functionalities is being performed, there is commonly other buttons, rotary knobs, sliders, scroll bars, and touchscreen displays which will not be used or not be used as much. The modular control device 10, 10A, 10Bs of the present disclosure maximize functionality via the twenty eight plurality of base members 21/22, as each plurality of electronic modules 30, 30A, 30B, having a variety of suitable sizes and shapes, can be easily arranged, having the most ideal layout of button modules 36, 36A, rotary knob modules 35, slider modules 37, scroll bar modules 34, and/or touchscreen modules 33, 33A for whatever layout of audio-editing, video-editing, live streaming, or internet browsing preferred by the user.

Additionally, the modular control devices 10, 10A, 10B of the present disclosure provide quick engagement and strong retention of the plurality of electronic modules 30, 30A, 30B to the mounting surface 201 of the module base 20. The snap-fit joint connection of the module interface 31/21 and the retention interface 32/22 is simple and easy, while also being a strong retention mechanism. The retention surface 309, being a largest surface area of each plurality of electronic modules 30, 30A, 30B, is engaged on the mounting surface 201, which is a top surface of the module base 20. The engagement of the plurality of electronic modules 30, 30A, 30B is stronger and more secure than electronic components electrically coupled via a side wall of a main control device, which is generally more prone to unwanted disengagement, loose connections, and damage. Moreover, electronic components electrically coupled via a side wall of a main control device can result in asymmetrical shapes. Thus, making it inconvenient for users with limited area for placement of the control devices, or symmetrically shaped desktops or tabletops.

Moreover, bays or fasteners on mounting surfaces 201 of control devices limit layout choices and add additional steps for engagement and disengagement of modules. In addition to the at least two or more retention joints 31/21, 32/22, at least one side 305A of each plurality of electronic modules 30, 30A, 30B is adjacent to one side of an other 305B of the plurality of electronic modules 30, 30A, 30B. Thus, engagement of each plurality of electronic modules 30, 30A, 30B to the module base 20 is supported, further eliminating the need for bays and additional engagement and disengagement steps due to the fasteners.

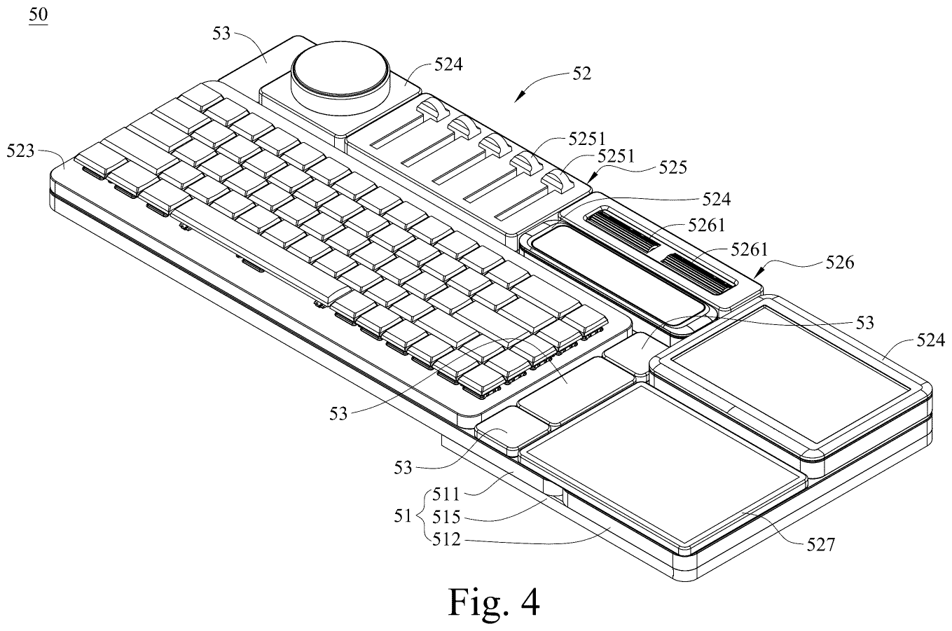

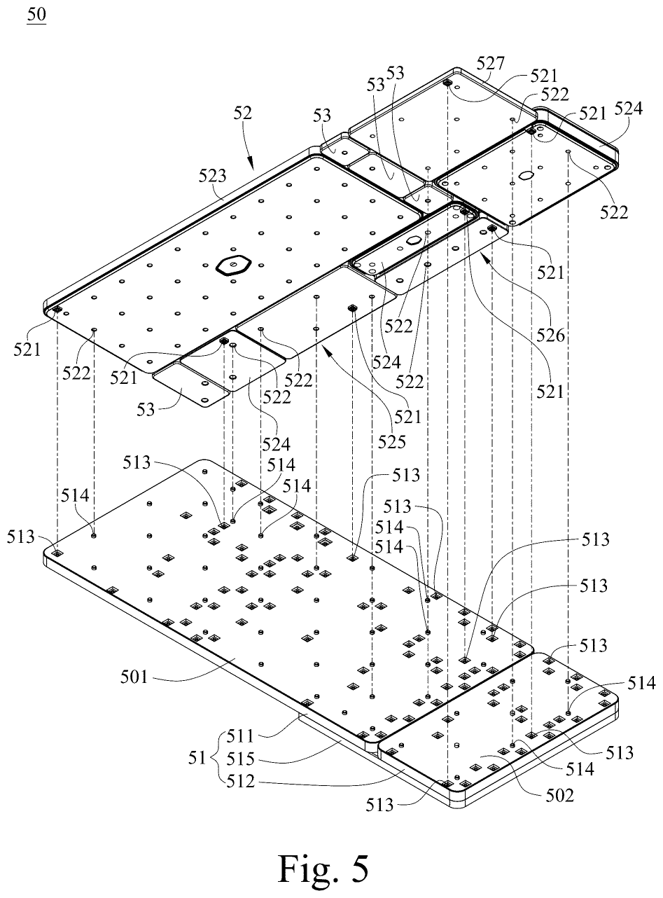

Please refer to FIGS. 4 and 5. FIG. 4 is a perspective view of yet another modular control device according to one embodiment of the present disclosure. FIG. 5 is an exploded view of the modular control device of FIG. 4 according to one embodiment of the present disclosure.

The modular control device 50 of this embodiment includes a module base 51 and multiple electronic modules 52. The module base 51 includes a main control body 511, an expandable control body 512, and a control body connector 515. The expandable control body 512 is disposed on the main control body 511 and can move relative to the main control body 511 to be located at a retracted position or an extended position. For example, the expandable control body 512 can slide horizontally relative to the main control body 511 to be located at the retracted position or extended position. More specifically, the expandable control body 512 is connected to the main control body 512 through the control body connector 515.

In detail, the main control body 511 and expandable control body 512 are arranged side by side, and when the expandable control body 512 is at the extended position, the spacing between the main control body 511 and expandable control body 512 is greater than the spacing between the main control body 511 and expandable control body 512 when the expandable control body 512 is at the retracted position. For example, when the expandable control body 512 is at the retracted position, the main control body 511 and expandable control body 512 are connected. When the expandable control body 512 is at the extended position, the main control body 511 and expandable control body 512 are separated.

Since the expandable control body 512 being at the retracted position and being at the extended position is only a positional difference, with the remaining structure being the same, the following description will be made with the expandable control body 512 at the retracted position. When the expandable control body 512 is at the retracted position, the dimensions of the module base 51 are, for example, 15×6.

The main control body 511 has a first mounting surface 501 with multiple first electrical connectors 513 and multiple first positioning structures 514. The expandable control body 512 has a second mounting surface 502 with multiple first electrical connectors 513 and multiple first positioning structures 514. Each electronic module 52 has a second electrical connector 521 and multiple second positioning structures 522. These second positioning structures 522 and these first positioning structures 514 are matching concave-convex structures. For example, these first positioning structures 514 are positioning protrusions, and these second positioning structures 522 are positioning grooves.

In one embodiment, the first electrical connectors 513 and first positioning structures 514 on the first mounting surface 501 and the second mounting surface 502 are arranged in a grid pattern for systematically positioning the electronic modules 52. The grid pattern includes a plurality of first electrical connectors 513 and first positioning structures 514 disposed in at least two or more columns and at least two or more rows.

The second electrical connector 521 can be detachably connected to one of these first electrical connectors 513, and positioned through these second positioning structures 522 and these first positioning structures 514, so that these electronic modules 52 are fixed to the module base 51 and electrically connected to the module base 51. In one embodiment, at least one of the connections between the second positioning structures 522 and first positioning structures 514 includes a snap-fit joint connection, wherein each electronic module 52 is engaged to and disengaged from the module base 51 via the snap-fit joint connection. Through the guidance of these second positioning structures 522 and these first positioning structures 514, these electronic modules 52 will not be displaced when installed on the module base 51. The form of these first electrical connectors 513 and second electrical connector 521 is, for example, USB.

The electronic module 52 includes, but is not limited to, a keyboard module 523, multiple touchscreen modules 524, an audio module 525, a scroll module 526, and a touchpad module 527. The keyboard module 523, these touchscreen modules 524, audio module 525, scroll module 526, and touchpad module 527 are disposed on the module base 51. In detail, the keyboard module 523, part of these touchscreen modules 524, audio module 525, and scroll module 526 are, for example, disposed on the main control body 511, and part of these touchscreen modules 524 and touchpad module 527 are, for example, disposed across the main control body 511 and expandable control body 512.

In this embodiment, the size of the keyboard module 523 is, for example, 60%, but is not limited thereto. The so-called 60% size keyboard module 523 refers to a keyboard module 523 without a numeric keypad area and arrow key area. These touchscreen modules 524 are, for example, LED displays or IPS (In-Plane Switching) displays, but are not limited thereto. The sizes of these touchscreen modules 524 are, for example, 4 inches, 4.6 inches, or 5 inches, but are not limited thereto. The audio module 525 is used to adjust the playback volume, and the number of adjustment sliders 5251 of the audio module 525 is, for example, 5, but is not limited thereto. The number of scroll wheels 5261 of the scroll module 526 is, for example, 2, but is not limited thereto.

In this embodiment, the modular control device 50 can also include multiple fill pieces 53. These fill pieces 53 are disposed on the module base 51. For example, these fill pieces 53 are disposed on the main control body 511. These fill pieces 53 are used to fill vacant positions on the module base 51 where electronic modules 52 are not disposed, to maintain the appearance of the modular control device 50.

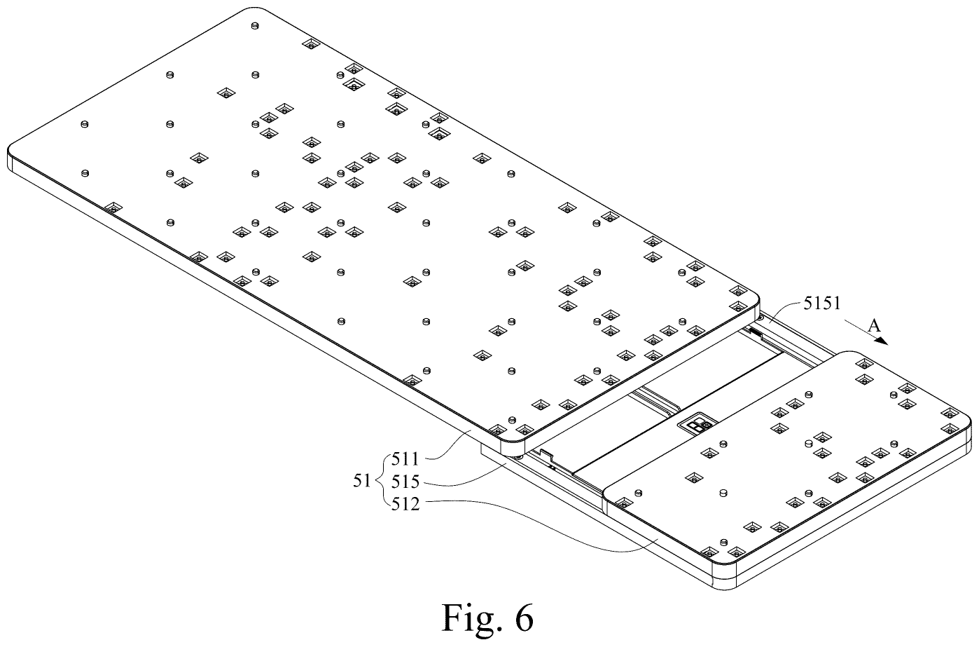

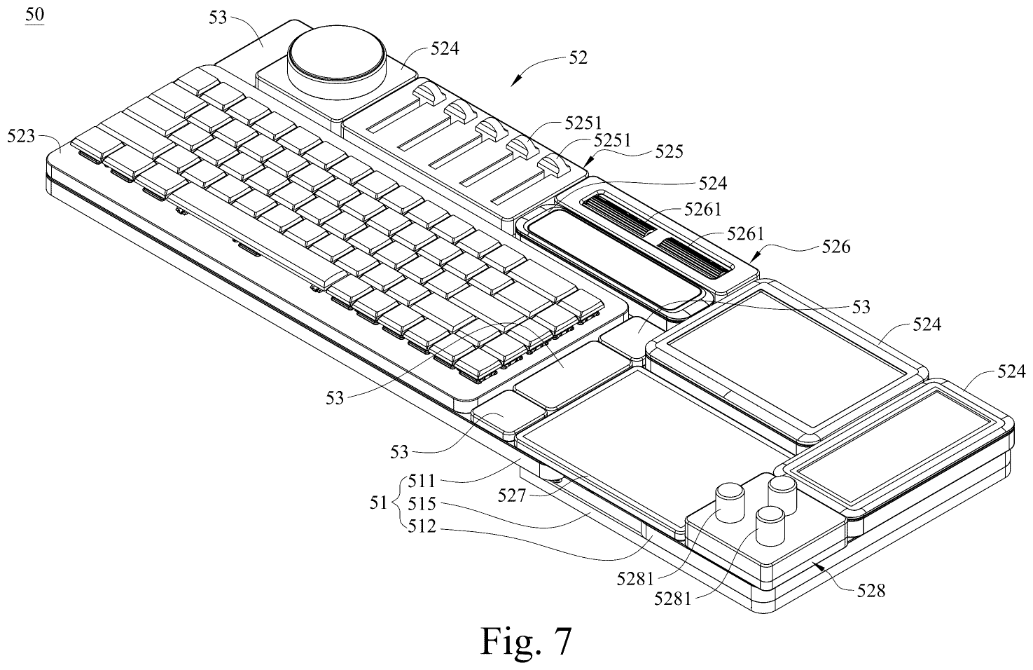

Please refer to FIGS. 6 and 7. FIG. 6 is a perspective view of the module base of the modular control device of FIG. 4 according to one embodiment of the present disclosure. FIG. 7 is another perspective view of the modular control device of FIG. 4 according to one embodiment of the present disclosure.

The control body connector 515 can be secured to either one of the main control body 511 and the expandable control body 512. For example, the control body connector 515 can be secured to the expandable control body 512 as shown in FIG. 6. The control body connector 515 can include a sliding mechanism 5151 where the expandable control body 512 is slidable relative to the main control body 511 by engaging the sliding mechanism 5151. In this embodiment, when the user slides the expandable control body 512 horizontally in direction A according to their needs, the expandable control body 512 moves from the retracted position to the extended position, so that the dimensions of the module base 51 can be expanded to, for example, 17×6. At this time, the electronic module 52 can also include, but is not limited to, a rotary knob module 528, and the keyboard module 523, part of these touchscreen modules 524, audio module 525, and scroll module 526 are, for example, disposed on the main control body 511, part of these touchscreen modules 524 and touchpad module 527 are, for example, disposed across the main control body 511 and expandable control body 512, and part of these touchscreen modules 524 and rotary knob module 528 are, for example, disposed on the expandable control body 512. The number of rotary knobs 5281 of the rotary knob module 528 is, for example, 3, but is not limited thereto.

In this embodiment, since the electronic module 52 can be detachably installed on the module base 51, users can install the electronic module 52 on the module base 51 according to their needs, without needing to replace the entire modular control device 50 causing cost waste, and can set the placement position according to their preferences, thereby achieving modular design, thus improving the flexibility and convenience of using the modular control device 50.

In addition, since the expandable control body 512 of the module base 51 can move relative to the main control body 511 to be located at the retracted position or extended position, when users need to install more electronic modules 52, they can move the expandable control body 512 from the retracted position to the extended position to expand the area in the module base 51 where electronic modules can be installed. In this way, the flexibility and convenience of using the modular control device 50 can be further improved.

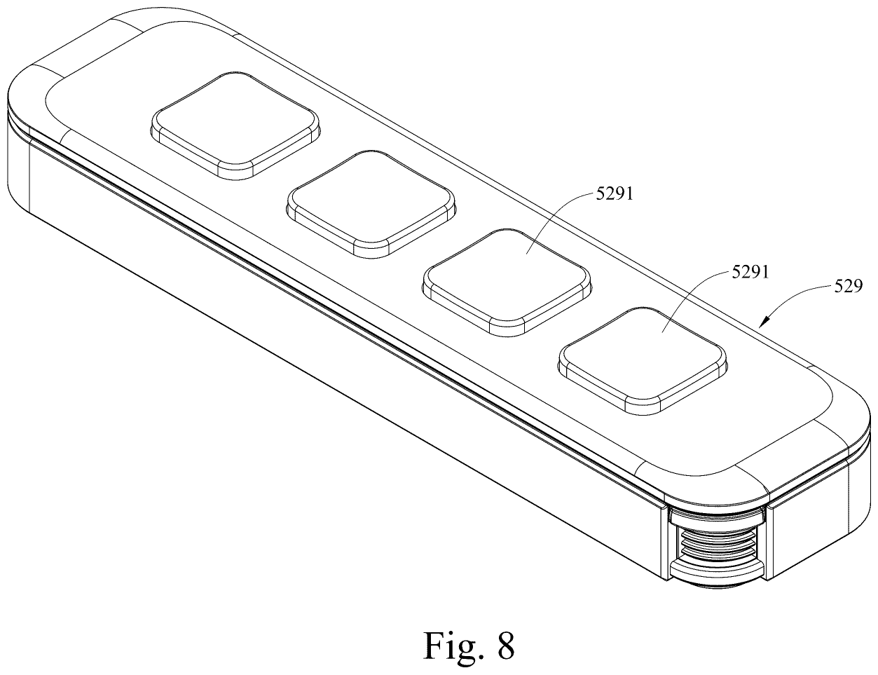

Please refer to FIG. 8. FIG. 8 is a perspective view of one type of electronic module of the modular control device of FIG. 4 according to one embodiment of the present disclosure. In this embodiment, the electronic module 52 can also include, but is not limited to, a button module 529, and the button module 529 is disposed on the module base 51. The number of buttons 5291 of the button module 529 is, for example, 4, but is not limited thereto.

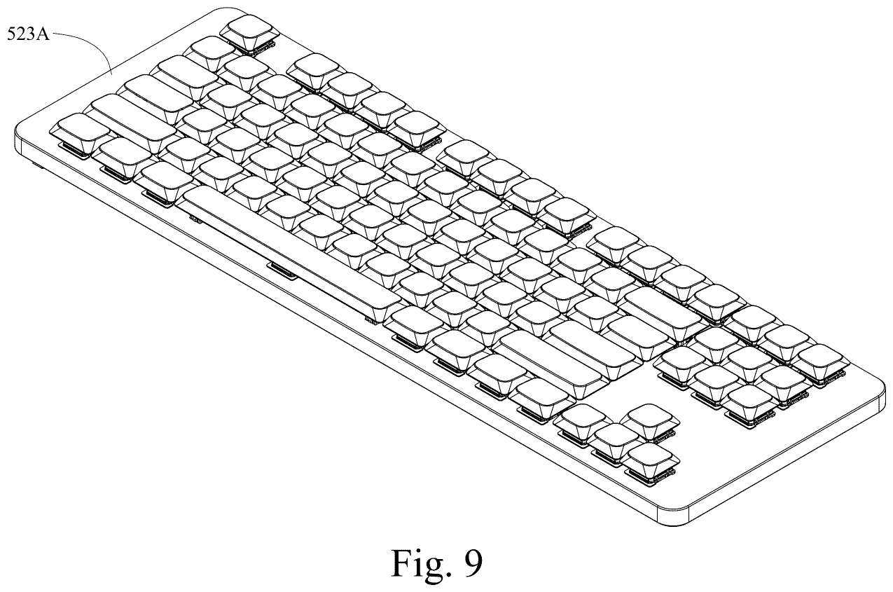

Please refer to FIG. 9. FIG. 9 is a perspective view of another type of electronic module of the modular control device of FIG. 4 according to one embodiment of the present disclosure. In this embodiment, the electronic module 52 can also include, but is not limited to, a keyboard module 523A with a size of, for example, 80%, and the keyboard module 523A is disposed on the module base 51. The so-called 80% size keyboard module 523A refers to a keyboard module 523 without a numeric keypad area.

In this embodiment, the number of electronic modules 52 can be multiple, but is not limited thereto. In other embodiments, the number of electronic modules can also be only one. In this embodiment, the number of second positioning structures 522 of the electronic module 52 can be multiple, but is not limited thereto. In other embodiments, the number of second positioning structures of the electronic module can also be only one.

In this embodiment, the expandable control body 512 can slide horizontally relative to the main control body 511, but is not limited thereto. In other embodiments, the expandable control body can also move relative to the main control body, for example, by horizontal rotation or vertical flipping to be located at the retracted position or extended position.

In this embodiment, these first positioning structures 514 are positioning protrusions, and these second positioning structures 522 are positioning grooves, but are not limited thereto. In other embodiments, these first positioning structures and these second positioning structures can also have their concave-convex arrangement reversed. That is, these first positioning structures can also be positioning grooves, and these second positioning structures can also be positioning protrusions.

In this embodiment, the form of these first electrical connectors 513 and second electrical connector 521 comprises universal serial bus (USB) interfaces, but is not limited thereto. The USB interfaces can include various form factors such as USB Type-A, Type-B, Mini-A, Mini-B, Micro-A, Micro-B, and Type-C. In specific implementations, USB3.2 Gen 1×1 can exchange data over USB-A, USB-C, or micro USB cables at speeds of at least 5 Gbps, while USB4 Version 2 can exchange data over USB Type-C cables at speeds of at least 80 Gbps. In other embodiments, these first electrical connectors and second electrical connector can also be signal-connected through wireless connection.

According to the modular control device of the above embodiments, since the electronic module can be detachably installed on the module base, users can install the electronic module on the module base according to their needs, without needing to replace the entire modular control device causing cost waste, and can set the placement position according to their preferences, thereby achieving modular design, thus improving the flexibility and convenience of using the modular control device.

In addition, since the expandable control body of the module base can move relative to the main control body to be located at the retracted position or extended position, when users need to install more electronic modules, they can move the expandable control body from the retracted position to the extended position to expand the area in the module base where electronic modules can be installed. In this way, the flexibility and convenience of using the modular control device can be further improved.

Therefore, embodiments disclosed herein are well adapted to attain the ends and advantages mentioned as well as those that are inherent therein. The particular embodiments disclosed above are illustrative only, as the embodiments disclosed may be modified and practiced in different but equivalent manners apparent to those of ordinary skill in the relevant art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A modular control device, comprising:
a module base comprising:
a main control body having a plurality of first electrical connectors and a plurality of first positioning structures;
an expandable control body having a plurality of first electrical connectors and a plurality of first positioning structures, wherein the expandable control body is movably positioned with respect to the main control body and configured to move between a retracted position and an extended position; and
a plurality of electronic modules, each electronic module having a second electrical connector and a plurality of second positioning structures,
wherein each electronic module is detachably connectable to the module base via connection of the second electrical connector to one of the first electrical connectors and positioning of the second positioning structures with the first positioning structures for electrical connection and mechanical positioning.

2. The modular control device of claim 1, wherein the module base further comprises a control body connector connecting the expandable control body to the main control body and configured to facilitate movement of the expandable control body between the retracted position and the extended position.

3. The modular control device of claim 1, wherein when the expandable control body is in the retracted position, the module base has dimensions of approximately 15×6, and when the expandable control body is in the extended position, the module base has dimensions of approximately 17×6.

4. The modular control device of claim 2, wherein the expandable control body is configured to move with respect to the main control body between the retracted position and the extended position via the control body connector.

5. The modular control device of claim 1, wherein the plurality of electronic modules are positioned across both the main control body and the expandable control body.

6. The modular control device of claim 1, wherein the plurality of electronic modules comprise at least one of: a keyboard module, a touchpad module, a button module, an audio module, a touchscreen module, a rotary knob module, or a scroll module.

7. The modular control device of claim 6, wherein the keyboard module comprises a 60%, 80%, or 100% size configuration.

8. The modular control device of claim 6, wherein the touchscreen module comprises a 4 inch, 4.6 inch, or 5 inch display.

9. The modular control device of claim 6, wherein the scroll module comprises 2 scroll wheels.

10. The modular control device of claim 6, wherein the rotary knob module comprises 3 knobs.

11. The modular control device of claim 6, wherein the button module comprises 4 buttons.

12. The modular control device of claim 6, wherein the audio module comprises 5 adjustment sliders.

13. The modular control device of claim 1, wherein the first electrical connectors and second electrical connector comprise universal serial bus (USB) interfaces.

14. The modular control device of claim 1, wherein the electrical connection between the first electrical connectors and the second electrical connector is a wireless connection.
